(19) United States
(12) Patent Application Publication
(10) Pub. No.: US 2004/0184773 A1
(43) Pub. Date: Sep. 23, 2004

(54) Digital video recorder having a Internet phone

(76) Inventors: Byeong-Jin Lim, Seoul (KR); In-Keon Lim, Seoul (KR)

Correspondence Address: VOLENTINE FRANCOS, P.L.L.C., Suite 150, 12200 Sunrise Valley Drive, Reston, VA, 20191, US

(21) Appl. No.: 10/801,674

(22) Filed: Mar. 17, 2004

(30) Foreign Application Priority Data
Mar. 17, 2003 (KR) 2003-16390

(51) Int. Cl. H04N 7/173; H04H 1/04; H04J 1/00; H04N 7/00

(52) U.S. Cl. 386/46; 725/133; 725/110; 725/112; 725/113

(57) ABSTRACT

An emergency voice communication technique through the Internet using a VoIP (Voice over Internet Protocol) Internet phone between a central control center and a digital video recorder or between remotely located digital video recorders. The operator of the digital video recorder immediately calls the Internet phone of a predetermined remote workstation only by lifting the handset of the Internet phone connected to the digital video recorder when an alarm event is generated in the digital video recorder. If an alarm event occurs in the remote workstation, the operator of the remote workstation immediately calls the Internet phone of the digital video recorder by lifting the handset of the Internet phone connected to the remote workstation. VoIP communication between remotely located digital video recorders can be carried out through a network or the Internet using Internet phones connected to the digital video recorders.

### CROSS REFERENCE TO RELATED APPLICATION

This application claims priority under 35 USC § 119 to Korean Patent Application No. 2003-16390, filed on Mar. 17, 2003, the contents of which are incorporated herein by reference in their entirety.

### FIELD OF THE INVENTION

Embodiments of the present invention relate to a digital video recorder (DVR). An emergency voice communication technique operates through the Internet using a VoIP (Voice over Internet Protocol). An Internet phone is connected to the DVR.

### BACKGROUND OF THE RELATED ART

Video recording systems may be used for security purposes at public institutions, financial institution windows, and other places requiring security. The video recording system records video data captured by a plurality of installed video cameras and monitors the video data.

A digital video recorder (DVR) can effectively store video data and reproduce high picture quality images. The digital video recorder can convert an analog video signal, captured by a video camera, into digital video data. MPEG compression and decompression for the digital video data can be performed to efficiently record and reproduce a large quantity of video data.

The video recorder detects or monitors a location or situation (e.g. an exit, entrance, or burglary) through a sensor. In an emergency, the sensor may be activated and raises an alarm or informs a central control center (e.g. remote workstation) of the emergency via a network. The video camera operating in connection with the sensor can transfer to a fast recording mode to record images when the sensor is activated. That is, the number of frames per second can be increased to improve monitoring capability.

In the case of emergency, however, the central control center should call the manager of a corresponding local digital video recorder using a general telephone through a general telephone network. However, it may take considerable time to search for the telephone number of a corresponding site and dial the number of the central control center. Accordingly, the emergency situation may end with undesirable consequences before the call can be placed.

### SUMMARY OF THE INVENTION

An object of embodiments of the present invention is to provide a digital video recorder including an efficient voice communication system capable of carrying out emergency voice communication in real time between the digital video recorder and a remote workstation. The remote workstation is connectable with the digital video recorder through a network (e.g. the Internet) when an emergency alarm is activated. Another object of embodiments of the present invention is to provide a digital video recorder having a VoIP system capable of executing voice communication among a plurality of digital video recorders that are remotely separated from one another and connectable through a network or the Internet, without using a general telephone.

To accomplish the objects of embodiments of the present invention, a digital video recorder, having an Internet phone, is used for voice communication among a plurality of digital video recorders that are remotely separated from one another. The digital video recorders are connected through a network (e.g. the Internet). A digital video recorder may also be connected to a remote workstation through a network.

A digital video recorder or remote workstation may have Windows or Linux operating systems installed. An Internet phone may be connected to a USB port of the digital video recorder or remote workstation. A speaker and a microphone of the Internet phone are interfaced with the digital video recorder or remote workstation through a USB sound card of a Windows or Linux based system, such that audio signals are transmitted through VoIP. Operations of pushing keypad buttons and lifting the handset of the Internet phone are interfaced to the digital video recorder through an application interface.

### BRIEF DESCRIPTION OF THE DRAWINGS

FIG. 1 is an exemplary illustration of a digital video recorder system.

FIG. 2 is an exemplary flow chart of a voice communication procedure of the digital video recorder.

FIG. 3 is an exemplary flow chart of a voice communication procedure executed between digital video recorders.

FIG. 4 is an exemplary illustration of an Internet phone set in the digital video recorder.

### DETAILED DESCRIPTION OF THE INVENTION

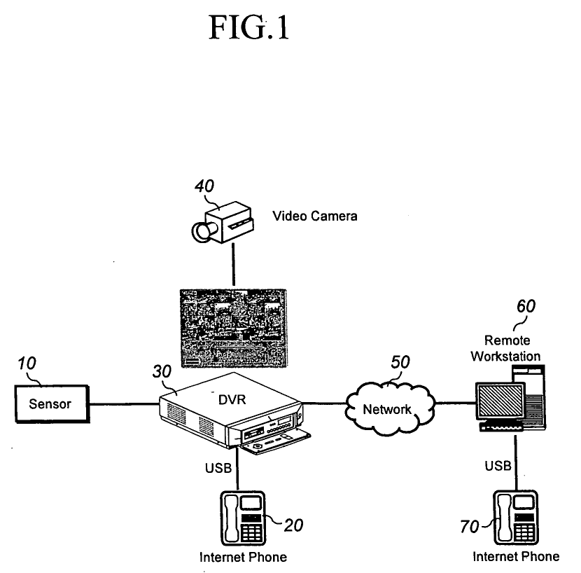

A digital video recorder system providing VoIP service according to the embodiments of present invention is explained with reference to FIGS. 1, 2, 3 and 4. Embodiments of the present invention connect an Internet phone to a USB port of a PC-based digital video recorder to enable VoIP communication. The VoIP communication is between the digital video recorder and a remote workstation, as well as between digital video recorders in separate locations. Embodiments of the present invention are applied to a PC-based digital video recorder. In the case that the operating system of the PC-based digital video recorder is Microsoft Windows or Linux, a plurality of digital video recorders can carry out VoIP communication among them through Internet phones connected to USB ports.

FIG. 1 is an exemplary illustration of a digital video system. When a sensor 10, connected to the digital video recorder 30, senses an abnormal state, the sensor 10 alerts the digital video recorder. A video camera 40, operating in connection with the sensor 10, then activates its recording operation. Alternatively, when the sensor 10 alerts the digital video recorder, the recording speed may temporarily increase. For example, the video camera 40 operating in connection with the alarm sensor 10 normally records images at relatively low recording speed (e.g. approximately 1-8 frames per second). When an alarm is raised, the video camera can increase the recording speed to record images at a higher speed and higher resolution (e.g. approximately 30 frames per second).

The local digital video recorder 30 may the notify a remote workstation 60 through a network 50 of event information about the alarm. The workstation may be a central control center. Images recorded at a high speed by the video camera 40 operating in connection with the sensor 10 are automatically transmitted to the remote workstation 60 together with the alarm event. The recorded images may be displayed on a screen of the remote workstation 60. The software program operating at the remote workstation knows the identification information of the local digital video recorder 30 that sent the emergency notification. Accordingly, the Internet phone 20 of the digital video recorder 30 can be automatically dialed as soon as the operator of the remote workstation lifts the handset of the Internet phone 70.

Embodiments of the present invention enable voice communication between a digital video recorder and a remote workstation without delay because Windows or Linux program installed in the PC-based digital video recorder 30 supports VoIP. In the related art, the operator of the remote workstation must locate a telephone number and dial the numbers to call a site where a corresponding digital video recorder is installed. In embodiments of the present invention, the operator of the digital video recorder 30 can lift the handset of the Internet phone 20 to call the IP address of the remote workstation without inputting a separate address when an alarm is activated. Likewise, since the program of the remote workstation already knows the IP address of the local digital video recorder 30 that has an activated alarm, the operator of the remote workstation 60 can directly call the Internet phone 20 of the digital video recorder 30 by lifting the handset of the Internet phone 70.

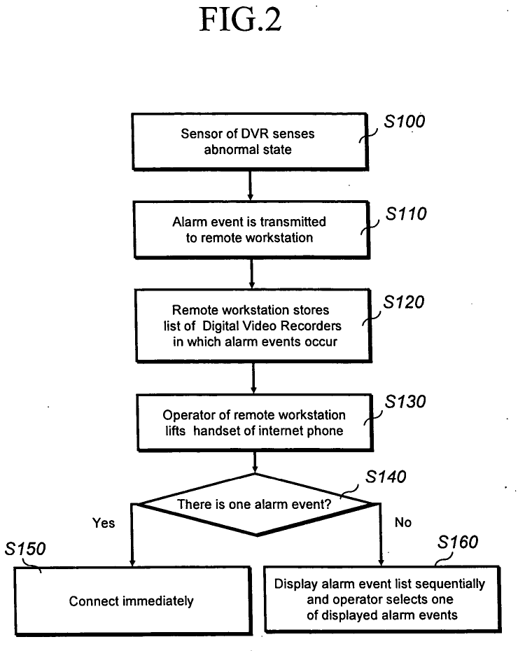

FIG. 2 is an exemplary flow chart of a voice communication procedure of a digital video recorder according to embodiments of the present invention. At step S100, when the sensor 10 of the digital video recorder 30 senses an abnormal state, an alarm is activated and the video camera operating in connection with the sensor performs a predetermined operation. At step S110, the digital video recorder 30 notifies the remote workstation 60 of the alarm event through the network 50.

The remote workstation 60 may store a list of digital video recorders that sent alarm event notifications at step S120. At step S130, the operator of the remote workstation, who recognizes the alarm event, lifts the handset of the Internet phone to connect with the operator of a corresponding digital video recorder. The operation of lifting the handset may be transmitted to the corresponding digital video recorder as a signal through the USB port of the remote workstation, so that a predetermined program installed in the digital video recorder can detect it.

When the remote workstation is notified of only one alarm event, the remote workstation 60 automatically calls the Internet phone 20 of the corresponding digital video recorder 30 as soon as its operator lifts the handset of the Internet phone 70 connected to the remote workstation 60 at step S150. When the remote workstation is notified of more than two alarm events, the alarm events are sequentially displayed on the monitor of the remote workstation. The operator of the remote workstation may then select one of them using a mouse or a keyboard to automatically call the Internet phone connected to the corresponding digital video recorder, at step S160.

Embodiments of the present invention can rapidly call the corresponding digital video recorder by only selecting one of digital video recorders displayed on the monitor of the remote workstation. This is distinguished from the related art in which the control center operator must locate a telephone number and push the key buttons one by one to place the emergency phone call.

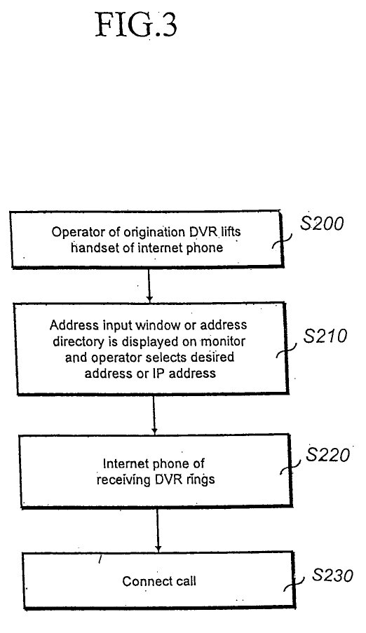

FIG. 3 is an exemplary flow chart of a voice communication procedure carried out between digital video recorders at different locations. In FIG. 3, the operator of an originating source digital video recorder lifts the handset of the Internet phone connected to the digital video recorder, at step S200. An IP address input window or a directory of the addresses of digital video recorders, to which the originating digital video recorder can be connected via a network or the internet, is displayed on the monitor of the originating digital video recorder, at step 210. The operator of the originating digital video recorder can select a desired digital video recorder or directly input the IP address of the digital video recorder. The Internet phone of the selected digital video recorder rings, at step 220. At step 230, the operator of the selected digital video recorder lifts the handset of the Internet phone connected thereto to communicate with the originating digital video recorder by telephone.

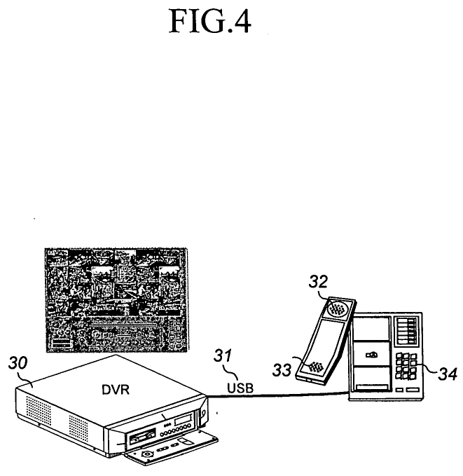

FIG. 4 shows the construction of the Internet phone set in the digital video recorder system according to embodiments of the present invention. The Internet phone set includes a keypad 34, a microphone 32 and a speaker 33. The Internet phone may be connected to the USB port of the digital video recorder 30. A USB sound card interface that interfaces the microphone 32 to the speaker 33 may be provided by a Microsoft Windows operating system or a Linux operating system.

An application interface (API) of a device driver provided by the Internet phone manufacturer may be used for interfacing the Internet phone (e.g. operation of lifting the handset or operation of pushing key pad buttons) to the digital video recorder. To execute voice communication using the Internet phone connected to the digital video recorder, audio input/output data can be transmitted via VoIP on a network or the Internet using H.323 and G.723.1 standard protocol. The VoIP service can be provided using NetMeeting RDK provided by Microsoft or H.232 source code provided by Linux.

According to embodiments of the present invention, the operator of the digital video recorder can immediately call the Internet phone of a predetermined remote workstation only by lifting the handset of the Internet phone connected to the digital video recorder when an alarm event is generated in the digital video recorder. If an alarm event occurs in the remote workstation, the operator of the remote workstation can immediately call the Internet phone of the digital video recorder by lifting the handset of the Internet phone connected to the remote workstation. Embodiments of the present invention enables VoIP communication between remote digital video recorders connected through a network or the Internet, using Internet phones connected to the digital video recorders.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art. Although the invention has been illustrated and described with respect to exemplary embodiments thereof, it should be understood by those skilled in the art that various other changes, omissions and additions may be made therein and thereto, without departing from the spirit and scope of the present invention. Therefore, the present invention should not be understood as limited to the specific embodiment set forth above but to include all possible embodiments which can be embodied within a scope encompassed and equivalents thereof with respect to the feature set forth in the appended claims.

What is claimed is:

1. A digital video recorder having an Internet phone, which is configured for voice communication among a plurality of remotely located digital video recorders connected through a network or the Internet or is configured for voice communication between the digital video recorder and a remote workstation, wherein:
the digital video recorder or remote workstation has a Windows or Linux operating system installed;
an internet phone is connected to a universal serial bus port of the digital video recorder or remote workstation;
a speaker and a microphone of the Internet phone are interfaced with the digital video recorder or remote workstation through a universal serial bus sound card of Windows or Linux system such that audio signals are transmitted through voice over internet protocol; and
operations of pushing key pad buttons and lifting the handset of the Internet phone are interfaced to the digital video recorder through an application interface.

2. The digital video recorder having an Internet phone as claimed in claim 1, wherein when a sensor connected to the digital video recorder senses an emergency situation to notify the remote workstation of an alarm event, the operator of the remote workstation immediately connects with the internet protocol address of the digital video recorder by lifting the handset of the Internet phone of the remote workstation to call the Internet phone of the digital video recorder to communicate with the operator of the digital video recorder via voice over internet protocol.

3. The digital video recorder having an Internet phone as claimed in claim 1, wherein, when a sensor connected to the digital video recorder senses an emergency situation notifies the remote workstation of an alarm event, the operator of the digital video recorder immediately connects with the internet protocol address of the remote workstation by lifting the handset of the internet phone of the digital video recorder to call the Internet phone of the remote workstation to communicate with the remote workstation via voice over internet protocol.

4. The digital video recorder having an Internet phone as claimed in claim 1, wherein, when the operator of the digital video recorder lifts the handset of the Internet phone of the digital video recorder, a directory of addresses of digital video recorders connectable with the digital video recorder through a network or the Internet or a separate internet protocol input window is displayed on the monitor of the digital video recorder, and the operator selects a desired address or directly inputs a desired internet protocol address to call the Internet phone of the digital video recorder corresponding to the selected address or internet protocol address so as to communicate with the selected digital video recorder through voice over internet protocol.

5. A method of connecting Internet phones respectively connected to universal serial bus ports of digital video recorders to an Internet phone connected to a universal serial bus port of a remote workstation, wherein the remote workstation is connectable with the digital video recorders through a network or the Internet, the method comprising:
when events are generated in the digital video recorders, automatically notifying the remote workstation of the events and storing identification information of the digital video recorders, such as internet protocol addresses; and
if there is only one event that has been recently notified, the operator of the remote workstation immediately calls the Internet phone of a corresponding digital video recorder to communicate with it through voice over internet protocol by lifting the handset of the Internet phone connected to the remote workstation; and
if there is a plurality of events that have been recently notified, the events are displayed in the order of time and the operator of the remote workstation selects one of the events to call the Internet phone of the digital video recorder corresponding to the selected event so as to communicate with the corresponding digital video recorder, through voice over internet protocol.

6. The method as claimed in claim 5, wherein:
if there is only one event that has been recently notified; and
if there is no event notified for a predetermined period of time after the remote workstation is notified of the events, displaying an address directory and IP address window to allow the operator of the digital video recorder or remote workstation to select a desired address or IP address instead of calling the selected address or IP address when the operator lifts the handset of the Internet phone.

7. A method of connecting remotely located Internet phones respectively connected to universal serial bus ports of a plurality of digital video recorders, wherein the digital video recorders are connected through a network or the Internet to allow the digital video recorders to communicate with one another through voice over internet protocol, comprising:
if the operator of an originating digital video recorder lifts the handset of the Internet phone connected to the originating digital video recorder, an address directory or an internet protocol address input window is displayed on the monitor of the originating digital video recorder and the operator of the originating digital video recorder selects a desired address or directly inputs a desired internet protocol address; and
if the Internet phone of a receiving digital video recorder corresponding to the selected address or internet protocol address rings and the operator of the receiving digital video recorder lifts the handset of the Internet phone of the receiving digital video recorder, the receiving digital video recorder communicates with the originating digital video recorder via voice over internet protocol.

8. An apparatus comprising a first digital video recorder configured to communicate using a voice over internet protocol.

9. The apparatus of claim 8, wherein the first digital video recorder is coupled to a video camera.

10. The apparatus of claim 9, wherein the video camera is a surveillance video camera.

11. The apparatus of claim 8, wherein an Internet phone is coupled to the first digital video recorder.

12. The apparatus of claim 11, wherein the Internet phone is coupled to the first digital video recorder through a universal serial bus connection.

13. The apparatus of claim 8, wherein the first digital video recorder is configured to communicate with a second digital video recorder using a voice over internet protocol.

14. The apparatus of claim 8, wherein the first digital video recorder is configured to communicate with a remote work station using a voice over Internet protocol.

15. The apparatus of claim 14, wherein:
the first digital video recorder is coupled to a first sensor;
if the first sensor is activated, then automatically initiating communication between the first digital video recorder and the remote workstation using a voice over Internet protocol.

16. The apparatus of claim 15, wherein the automatically initiating communication causes an Internet phone of the remote workstation to ring when an Internet phone of the first digital video recorder is activated.

17. The apparatus of claim 16, wherein the Internet phone of the first digital video recorder is activated by an operator of the first digital video recorder picking up the receiver of the Internet phone of the first digital video recorder.

18. The apparatus of claim 15, wherein the automatically initiating communication causes an Internet phone of the first digital video recorder to ring when an Internet phone of the remote workstation is activated.

19. The apparatus of claim 18, wherein the Internet phone of the remote workstation is activated by an operator of the remote workstation picking up the receiver of the Internet phone of the remote workstation.

20. The apparatus of claim 15, wherein:
the remote workstation is configured to communicate with a second digital video recorder;
the second digital video recorder is coupled to a second sensor;
if the first sensor and the second sensor are activated at the same time, then the remote workstation selectively communicates with either the first digital video recorder or the second digital video recorder by an option to be automatically connected using a voice over Internet protocol to either the first digital video recorder and the second digital video recorder.
